(19) United States
(12) Patent Application Publication
(10) Pub. No.: US 2006/0289255 A1
(43) Pub. Date: Dec. 28, 2006

(54) Disc brake pad cushions

(76) Inventor: Philip Herbert Adams, Tallahassee, FL (US)

Correspondence Address: PHILIP H. ADAMS, 3721 LONGFORD DRIVE, TALLAHASSEE, FL, 32309, US

(21) Appl. No.: 11/166,569

(22) Filed: Jun. 25, 2005

(51) Int. Cl. F16D 65/78

(52) U.S. Cl. 188/218 XL

(57) ABSTRACT

Cushions (12 & 20) for disc brake pads (32 & 38), cushions being disposed between said brake pads and their corresponding caliper pistons (46) or caliper fingers (48). Cushions possess such characteristics of resilience that, during braking action, brake pads are allowed to “follow” the irregularities (ride over the high spots) on their corresponding rotor faces (44). This action significantly reduces frictional drag, which lowers braking temperature. Lower braking temperature translates directly into increased braking efficiency and brake system longevity. Each cushion comprises a resilient body—either a material, such as an elastomeric pad; or, a structure, such as a compressible spring; or, a device, such as a hydraulic or pneumatic damper—and a means for securing the cushion in place, such as spot welds, clips of various designs, adhesives, rivets, screws, mating physical features, or et cetera.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to disc brake systems, specifically to the types that are commonly used on road vehicles.

2. Prior Art

Disc brake systems are well known, having been used extensively in the automotive industry for many years. The prior art concerning disc brakes includes systems that are produced in a wide variety of sizes, types, and configurations, but the basic purpose of all such friction devices is the same—to convert kinetic energy (the energy of motion) into thermal energy (heat). By design, the friction between disc brake pads and brake rotors during braking generates tremendous quantities of heat as brake systems work to slow or stop moving vehicles.

However, although the prior art includes many methods and devices for dissipating and/or insulating brake-generated heat, there is a problematic aspect of brake heat generation which has been essentially unrecognized. This aspect has to do with the generation of excessive heat at friction interfaces (pad/rotor interfaces) during braking, a phenomenon which has a significant, adverse effect on braking efficiency and brake system longevity.

The Unrecognized Problem

It is not only natural but also unavoidable that brake rotors distort during use because of thermal expansion in the presence of the intense pressures, frictional drag, and other dimensional factors involved in braking action. As rotors repeatedly heat up and cool down, permanent irregularities develop on their friction faces. These irregularities may be referred to as “high spots”. High spots begin to develop as soon as rotors are put into service, and although they tend to develop gradually during normal brake use, they nonetheless begin to affect braking dynamics as soon as they begin to form—long before their presence becomes noticeable to drivers as a “pulsating pedal”.

It is well known that the “column of fluid” which presses brake pads against rotor faces during braking is typically pressurized to several hundred psi. Thus, because of the incompressible nature of liquids, disc brake pads are pressed against their corresponding rotor faces by a highly pressurized but incompressible column of fluid.

Therefore, when brakes are applied, and brake pads are pressed against rotating rotor faces by highly pressurized, incompressible fluid, high spots on the rotor faces are forced to “squeeze” between the pads as the rotors rotate. The brake pads, of course, resist any backward movement because of the incompressible fluid behind them (“backward movement” refers to movement of the pads perpendicular to and away from the face of the rotor, and will hereafter be termed “lateral” movement). Thus, as high spots on the rotor faces pass between applied pads during braking, severe and excessive frictional drag is produced. This generates much more heat than would be the case if there were no high spots on the rotors.

The problem which has been unrecognized in the prior art then is that the severe frictional drag between rotor high spots and brake pads during braking generates excessive heat. Perhaps the fact that brake systems are designed to generate tremendous quantities of heat has obscured recognition of the role that rotor high spots play in the generation of excessive friction and heat.

Common Problems Caused or Aggravated by High Spot Friction

It is known that brake systems operate at varying degrees of efficiency until friction interface temperatures reach the 205-232° C. (400-450° F.) range, and that as interface temperatures continue to climb above this “efficiency threshold”, there is a corresponding drop in brake efficiency. The hotter brakes get (above the efficiency threshold), the less efficient they become.

It is also known that the rate of wear of brake system friction components (pads and rotors) increases as braking temperatures increase.

Thus, the unrecognized problem (excessive heat generated by high-spot friction) is the underlying cause of reduced braking efficiency, accelerated brake wear, and other commonly recognized problems. These problems include:
(1) Extended stopping distance. During a typical braking cycle (from brake application to brake release), temperatures at pad/rotor interfaces routinely climb above the efficiency threshold, which lowers friction coefficients, reduces brake system efficiency, and extends normal stopping distances;
(2) Brake “fade”. During heavy, frequent, or prolonged braking cycles, pad/rotor interface temperatures can reach or exceed 538° C. (1,000° F.), which results in the dangerous condition known as brake “fade” (loss of friction);
(3) Accelerated pad wear. It is well known that, as braking temperatures increase, the rate of wear of brake friction material (brake pads) also increases;
(4) Rotor degradation. It is also well known that rotors, when they are worked at temperatures above the efficiency threshold, exhibit a greater tendency for scoring, glazing, cracking, and blue-spotting; and
(5) Shortened caliper life. The service life of calipers is also shortened by excessive heat. Excessive heat is the primary cause of caliper boot and seal failure, and is the major factor in caliper seizing caused by “gummy” (heat-compromised) lubricants.

Further problems caused by severe frictional drag at high spots (related more directly to frictional drag itself than to the excessive heat it generates) are these:
(6) Wheel lockup. During even moderate brake applications, because of the severe frictional drag which occurs at rotor high spots, there is an increased danger of one or more wheels locking up. When a wheel locks up, it is invariably at a rotor high spot. High-spot friction can become greater than tire-to-road friction, especially when road surfaces are slippery or tires are worn. This danger becomes acute by the time high spots have grown to such proportions that they are noticeable to the driver as a pulsating pedal; and
(7) Sway. During any braking cycle, the frictional drag at high spots on rotating rotor faces creates an uneven transfer of braking torque through the tires to the roadway, which reduces vehicle stability (particularly when towing) and increases vehicle “sway”, especially on unevenly-loaded or high-bodied vehicles. The uneven transfer of braking torque through the tires to the roadway also stresses tire assemblies, which causes external tire problems such as “cupping” and contributes significantly to internal tire problems such as cord separation.
   Excessive Friction and Heat Problems in the Prior Art

Brake system engineers have long recognized the problems caused by excessive brake-generated heat, and, as mentioned above, many methods and devices have been proposed to insulate and/or dissipate brake-generated heat in the attempt to improve brake efficiency and longevity. For instance, U.S. Pat. No. 6,796,405 (Ruiz, 2004), U.S. Pat. No. 6,119,820 (Steptoe, et al., 2000), U.S. Pat. No. 5,878,848 (Zhang, 1999), and U.S. Pat. No. 5,161,652 (Suzuki, 1992), among others, describe various ways of ventilating rotors to help dissipate brake-generated heat into the air.

U.S. Pat. No. 6,508,340 (Bunker, 2003) and U.S. Pat. No. 5,330,034 (Rancourt, et al., 1994) describe vanes and air scoops, respectively, to improve the cooling of brake assemblies by forcing air over and through them. U.S. Pat. No. 6,315,091 (Nilsen, et al., 2001) describes a method for channeling “ram” air to brake assemblies for cooling, and U.S. Pat. No. 6,578,678 (Lee, 2003) provides a splash shield to divert air to rotors for cooling.

U.S. Pat. No. 6,722,476 (Cornolti, 2004) and U.S. Pat. No. 6,491,139 (Budica, 2002) describe methods for dissipating brake heat with cooling liquids.

U.S. Pat. No. 6,419,054 (Schulba, 2002) describes a system of nozzles that spray liquefied nitrogen and carbon dioxide on brake assemblies, for cooling.

U.S. Pat. No. 6,085,636 (Ruckert, et al., 2000) describes a caliper piston with improved heat conductivity which helps reduce pad degradation caused by excessive braking temperatures.

U.S. Pat. No. 4,373,615 (Melinat, 1983) describes a laminated disc brake pad assembly with ceramic and rubber-like layers designed to provide a heat barrier for the prevention of brake fluid boiling and to suppress brake-generated noise.

U.S. Pat. No. 6,446,770 (Qian, et al., 2002) describes a rotor with grooved faces which minimize thermal distortions (high spots). However, the grooved rotor of Qian's invention, although it slows the formation of high spots, does not eliminate their formation, and no provision is made for reducing high-spot friction once the high spots begin to form.

Also, to combat the problem of wheel lockup (problem #6, above), many versions of electronic anti-lock brake systems have been invented. These systems, however, are designed to engage only during “lockup” stops for the purpose of providing steering control, and do nothing to improve brake efficiency during normal stops, which make up the vast majority of stops made during the life of any vehicle.

Additionally and in general, there have been other attempts to reduce the harmful effects of excessive brake-generated heat. For example, friction material (brake pad) composition has evolved from asbestos-laden recipes to semi-metallic and non-organic recipes which not only withstand excessive heat more effectively, but also absorb and dissipate heat more effectively. Brake fluids with higher boiling points have been developed. Low-drag calipers and step-bore master cylinders have been developed to reduce the heat generated by non-braking wear.

However, although each of the above methods/devices provides some measure of improvement in overall brake system efficiency, and/or helps to solve the commonly recognized problems caused by excessive braking heat, none of them address the underlying problems of (a) excessive heat generated by high-spot friction, and (b) the wheel lockup and torque transfer problems caused by severe frictional drag at high spots.

Solving the Problem

One method for solving the problems described above would involve increasing the size of disc brake systems—using larger (and thicker) rotors and larger-area brake pads (which would require larger calipers and redesigned master cylinders, et cetera). This method would practically eliminate the formation of high spots on rotor faces by improving the ratio of friction material area to vehicle weight and by increasing the heat-sink capabilities of brake assemblies, resulting in lower brake operating temperatures. However, this method would add undesired weight to vehicles and would be prohibitively expensive to implement.

Another method would involve providing a cushion (such as a hydraulic accumulator) inside the brake hydraulic system, which, if designed and calibrated correctly, could reduce high-spot friction and provide more efficient braking. Actually, several devices of this general type have been proposed (U.S. Pat. No. 5,265,942, issued to Jones in 1993; U.S. Pat. No. 5,820,227, issued to Spero in 1998; and U.S. Pat. No. 6,322,160, issued to Loh, et al. in 2001, for instance), but these (and similar) devices are designed to absorb hydraulic shock, and do not recognize the role that high spots play in the generation of excessive heat during braking. However, even if such a device were designed and calibrated specifically to provide optimum high-spot friction compensation, it would nonetheless be difficult to market because of consumer cost and liability issues.

So, there remains a need for a simple and cost-effective method for reducing high spot friction and heat—which brings us to the method of this invention.

The method of this invention is to provide a mechanical cushion between brake pads and their corresponding caliper members with such characteristics of resilience that brake pads are allowed to follow the irregularities (ride over the high spots) of their corresponding rotor faces while under pressure during braking. Such cushioning significantly reduces high-spot friction, which lowers operating temperatures and increases brake system efficiency.

Resilient Shims in the Prior Art

The use of resilient brake pad shims (cushions) is not unknown in the prior art. For instance, U.S. Pat. No. 3,885,651 (Odier, 1975), U.S. Pat. No. 4,093,045 (Kawamura, 1978), and U.S. Pat. No. 4,660,685 (Thacker, et al., 1987), among others, describe resilient shims which are placed in disc brake systems in generally the same location that my invention occupies—between outboard brake pads and outboard caliper fingers, and/or between inboard brake pads and caliper pistons. However, the shims of these patents are designed specifically to attenuate high-frequency vibrations and eliminate brake “squeal”, and do not possess the special characteristics of resilience required to solve high-spot friction and heat generation problems (the vibrations caused by frictional drag at rotor high spots occur entirely within a much lower frequency range, and at a much higher amplitude, than do audible vibrations).

Similarly, the vibration (squeal) attenuator disclosed in U.S. Pat. No. 5,014,827 (Wang, et al., 1991), although it is resilient and is placed on the face of a caliper piston, does not possess the special characteristics of resilience required to solve high-spot friction and heat-generation problems.

The prior art, then, although it contains methods and devices designed to compensate for excessive braking heat after it is generated, does not contain a method or device designed to prevent the generation of excessive heat by severe frictional drag at rotor high spots. The prior art also contains methods and devices which, although similar to my invention in structure and in their placement in disc brake assemblies, are nonetheless designed to solve an entirely different problem (brake squeal), and do not possess the characteristics of resilience necessary to solve the problem of excessive heat generation during braking.

It should be mentioned here that, although the prior art solutions for brake squeal do not solve the problem of excessive heat generation at rotor high spots, the reverse is not true; that is, solving the problem of excessive heat generation at rotor high spots by the method of this invention also effectively attenuates high-pitched brake squeal.

### OBJECTS AND ADVANTAGES

Accordingly, several objects and advantages of the present invention are:
(a) to provide a cushion for disc brake pads with such characteristics of resilience that brake pads are allowed to follow the irregularities (ride over the high spots) of their corresponding rotor faces while under pressure during braking, an action which results in lower brake operating temperatures;
(b) to provide a cushion for disc brake pads which shortens stopping distance;
(c) to provide a cushion for disc brake pads which prevents or delays brake fade;
(d) to provide a cushion for disc brake pads which reduces the rate of brake pad wear;
(e) to provide a cushion for disc brake pads which extends the service life of rotors and calipers;
(f) to provide a cushion for disc brake pads which significantly lessens the frictional drag which occurs at high spots on rotor faces, an effect that reduces the incidence of wheel lockup; and
(g) to provide a cushion for disc brake pads which smoothes the transfer of braking torque through the tires to the roadway, an effect which increases vehicle stability and lessens tire strain during braking, and extends tire life.

Further objects and advantages are to provide a cushion for disc brake pads which is compatible with any disc brake system and with any electronic ABS, which shortens stopping time (helping to compensate for slowed reaction time of elderly drivers, poor visibility, or surprises in traffic), which is inexpensive for consumers, which is easy to install, which effectively attenuates brake squeal, and which never requires any maintenance or adjustment. Still further objects and advantages will become apparent from a consideration of the ensuing description and drawings.

### SUMMARY

In accordance with the present invention, disc brake pad cushions comprise: (a) resilient devices with such characteristics of resilience that, when the resilient devices are secured in place between disc brake pads and their corresponding caliper members, the brake pads are allowed to follow the irregularities (ride over the high spots) on their corresponding rotor friction faces while under pressure during braking, and (b) means for securing the resilient devices in place.

### DRAWINGS—FIGURES

FIG. 1 shows a perspective view of a typical inboard brake pad cushion.

FIG. 2 shows a perspective view of a typical outboard brake pad cushion.

FIGS. 3A and 3B show inboard and outboard brake pad cushions, respectively, with peel-and-stick adhesive applied to one side, with cover partially peeled back

FIGS. 4A and 4B show inboard and outboard brake pad cushions, respectively, each with slits provided on one face for shear force compensation.

FIG. 5 shows the placement of brake pad cushions in a typical disc brake system.

FIGS. 6A and 6B show inboard and outboard brake pad cushions, respectively, made from wave springs.

FIG. 7 shows a typical leaf-type spring adaptable for inboard and outboard brake pad cushioning.

FIGS. 8A and 8B show inboard and outboard brake pad cushions, respectively, made from convex washers.

### DRAWINGS—REFERENCE NUMERALS

12 inboard brake pad cushion
20 outboard brake pad cushion
26 peel-and-stick adhesive (inboard cushion)
28 peel-and-stick adhesive (outboard cushion)
30 slits on cushion faces
32 inboard brake pad
34 inboard brake pad backing plate
38 outboard brake pad
40 outboard brake pad backing plate
44 rotor friction face
46 caliper piston (caliper body not shown)
47 caliper piston face (caliper body not shown)
48 outboard caliper fingers (caliper body not shown)
60 inboard cushion (wave spring)
62 outboard cushion (wave spring)
70 typical leaf spring adaptable for inboard and outboard brake pad cushioning
80 inboard cushion (convex washer)
82 outboard cushion (convex washer)

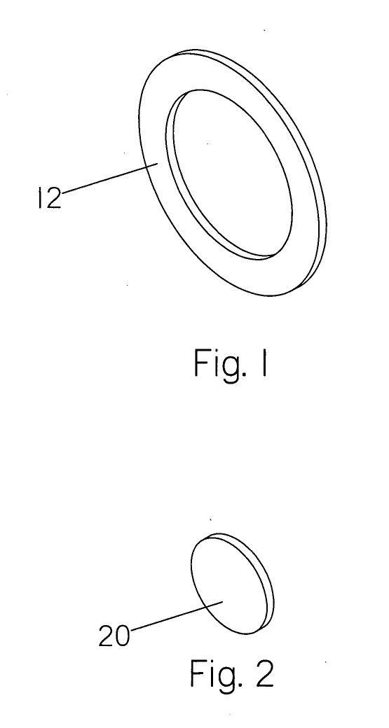

### DETAILED DESCRIPTION—FIGS. 1, 2, 3 A&B, 4 A&B, and 5—PREFERRED EMBODIMENT

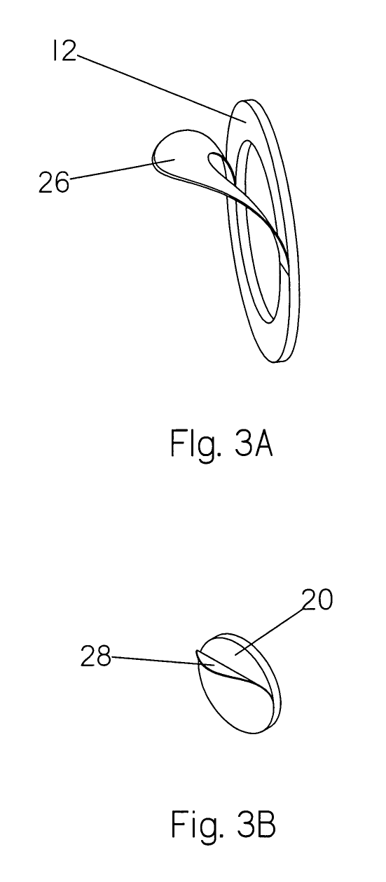

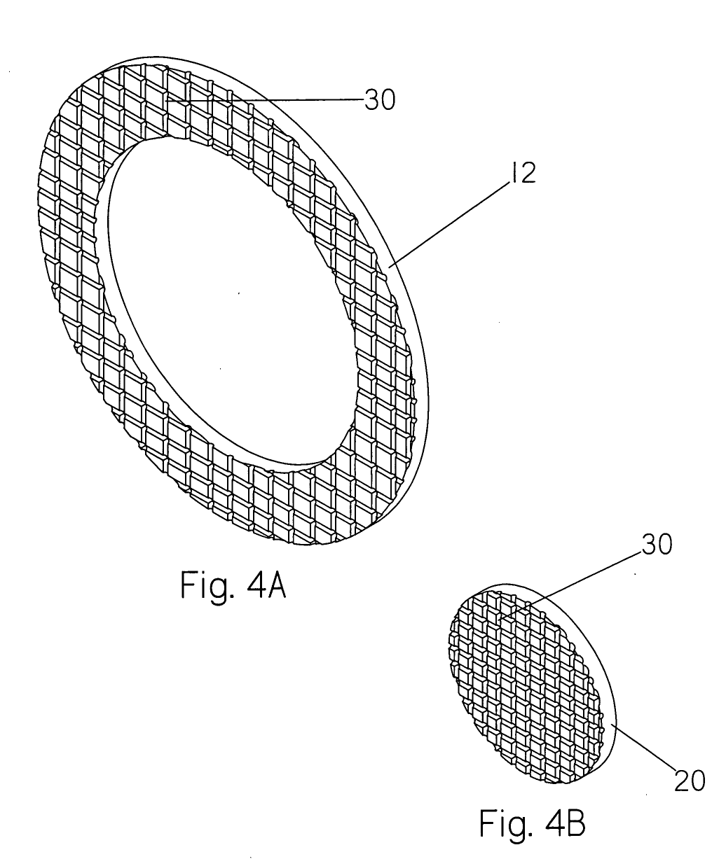

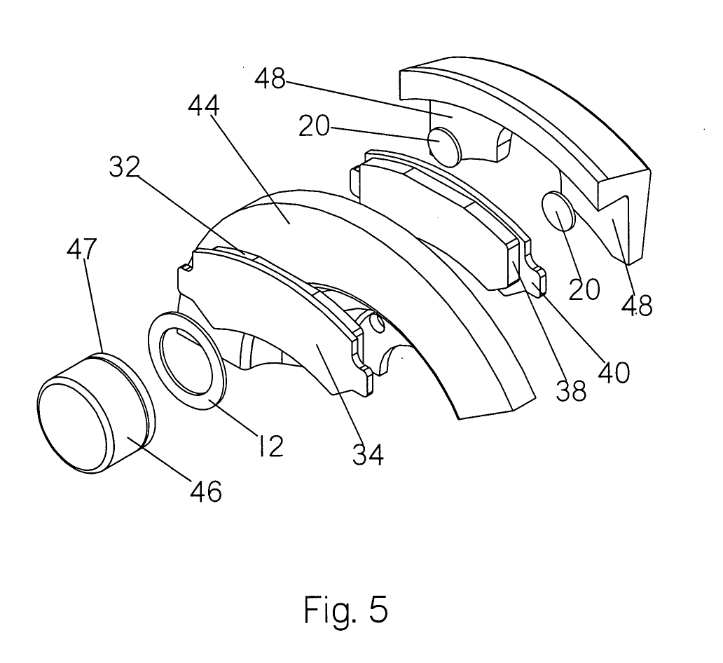

A preferred embodiment of the brake pad cushions of the present invention is illustrated in FIG. 1 (perspective view of a typical inboard brake pad cushion 12) and FIG. 2 (perspective view of a typical outboard brake pad cushion 20). A “set” of brake pad cushions for most applications includes inboard and outboard pad cushions, which, for any single application, are made from identical material. “Peel-and-stick” adhesive 26 and 28, used to secure the cushions in place, is illustrated in FIGS. 3A and 3B. Slits 30 on one face each of cushions 12 and 20, designed to compensate for shear forces during braking (caused by worn brake pad abutments, for instance), are illustrated in FIGS. 4A and 4B. Placement of the brake pad cushions in a typical disc brake system is illustrated in FIG. 5.

Cushion Material—Preferred Embodiment

In the preferred embodiment, the cushions are cut from a sheet (or molded from a mixture) of elastomeric material which is a blend of natural rubber (NR) and polybutadiene rubber (BR) in an approximate ratio of 75% NR to 25% BR. Small amounts of aromatic amines approximately 1-4 parts per hundred rubber) are also incorporated in the blend to prevent the possibility of metal-catalyzed oxidation, which could otherwise occur when the cushions are mounted on brake systems using cast-iron calipers. Such a compound can be obtained from Goodyear Tire and Rubber Company of Akron, Ohio, USA, or from other rubber mixing companies.

Cushions made from this particular elastomeric compound provide very high rebound resilience with very low heat buildup from cyclic (high spot) deformation. They exhibit very low compression-set and stress-relaxation characteristics, and very good resistance to abrasion, tear, and fatigue. However, although cushions made from this particular compound perform very well, maintain their integrity in service, and provide the intended benefits (including squeal damping) for all typical applications, the cushions can, of course, be made from other compounds. There are many elastomeric compounds—natural and synthetic—which could be used to make cushions which could satisfy the performance objectives set forth in this specification in a generally acceptable way. In fact, with further research and testing, application-specific cushions can easily be developed and produced. For instance, disc brake systems in severe-service applications such as racing cars or aircraft, which encounter extremely high braking temperatures, can benefit from cushions which have been designed specifically to operate in their particularly rigorous environments.

Cushion Shape and Size—Preferred Embodiment

In the preferred embodiment, the inboard brake pad cushion 12 (FIGS. 1 and 5) is shaped like a flat washer, open in the center. The inside and outside diameters of the cushion, as well as the difference between the inside and outside diameters (the width of the cushion material), can vary by application. Inboard cushion 12 is designed to match and cover the contact pattern (“footprint”) of a caliper piston 46 on the backing plate 34 of its corresponding brake pad 32 (FIG. 5)—hence, the preferred “O” shape shown in FIGS. 1 and 5. These cushions, however, can be given various shapes, sizes, or configurations—the important consideration concerning the shape and size of inboard cushions being that there is adequate cushioning between a caliper piston 46 and the backing plate 34 of its corresponding brake pad 32 to provide appropriate resilience during braking.

In the preferred embodiment, the outboard brake pad cushions 20 (FIGS. 2 and 5) are shaped like discs. For most applications, two outboard cushions are required, one for each caliper finger 48 (FIG. 5). The diameter of the cushions can vary by application, but is generally within the range of 25-30 mm. Outboard cushions are designed to provide cushioning in the areas of contact between caliper fingers 48 and the backing plate 40 of their corresponding brake pad 38 (FIG. 5). These cushions can be given various shapes, sizes, and configurations—the important consideration being that there is adequate cushioning between the caliper fingers 48 and the backing plate 40 of the outboard brake pad 38 to provide appropriate resilience during braking.

Brake systems which incorporate “fixed” calipers with opposed pistons use the above inboard cushion 12 design for each piston. This includes those pistons which apply an outboard brake pad.

Cushion Thickness—Preferred Embodiment

Cushions 12 and 20 (FIGS. 1, 2, and 5), which are identical to one another in thickness for any single application, can vary in thickness from application to application. Typical thicknesses range from 1.6 mm to 3.6 mm. Applications such as large motor homes, busses, and trucks generally use somewhat thicker cushions because the high spots which develop on their rotor friction faces 44 become proportionately larger than in applications such as automobiles, pickup trucks, and motorcycles, which develop proportionately smaller high spots and use somewhat thinner cushions. The important consideration concerning cushion thickness is that there is an adequate thickness of cushion material with the appropriate resilience to accommodate the high spots that typically form on the rotor friction faces of any particular application.

Cushion Mounting and Placement—Preferred Embodiment

In the preferred embodiment, one side of inboard cushion 12 is provided with peel-and-stick adhesive 26, and one side of each outboard cushion 20 is provided with peel-and-stick adhesive 28 (FIGS. 3A and 3B)—available from 3M Company—to secure the brake pad cushions in place. However, although the use of peel-and-stick adhesive to secure the cushions in place is very simple, convenient, and inexpensive for “do-it yourself” consumers, professional mechanics, and brake manufacturers alike, there are, of course, various ways to secure the cushions in place. This includes (but is not limited to) methods such as using peel-and-stick adhesive on both sides of the cushions, using other appropriate types of adhesive, using clips of various designs, using rivets, screws, or bolts, or providing mating physical features on the cushions and/or on their corresponding caliper members or brake pad backing plates which serve to “lock” them together. Still further methods for attaching or securing cushions in place during brake pad or caliper manufacture (such that caliper assemblies or sets of brake pads could be sold with cushions attached or included in packaging) can easily be devised—the important consideration here being that the cushions remain securely in place throughout the service life of the brake pads.

In the preferred embodiment, the inboard cushion 12 may be adhered either to the face 47 of its caliper piston 46 or to the backing plate 34 of its corresponding brake pad 32, and the outboard cushions 20 may be adhered either to the caliper fingers 48 or to the backing plate 40 of their corresponding brake pad 38 (FIG. 5).

Operation—Preferred Embodiment

Making use of the brake pad cushions 12 and 20 (FIGS. 1 and 2) to improve braking efficiency is a simple matter of properly installing the cushions in a disc brake system. The cushions may be installed at the time brake pads are replaced or at any time during brake pad life. Any person possessing the skill and the tools necessary to remove and replace a set of disc brake pads can easily and safely install a set of the brake pad cushions.

Installation involves following the vehicle manufacturer's instructions for replacing disc brake pads, with the following simple addition: after making sure that brake pad backing plates 34 and 40, caliper piston face 47, and caliper fingers 48 are clean and dry, peel-and-stick the brake pad cushions 12 and 20 in place (FIG. 5). Inboard brake pad cushion 12 fastens either to the caliper piston face 47 or to the contact area of the caliper piston face 47 on the inboard brake pad backing plate 34. Outboard brake pad cushions 20 fasten either to the caliper fingers 48 or to the outboard brake pad backing plate 40, in the contact area of the fingers with the brake pad backing plate.

Peel-and-stick adhesive may be provided on one or both sides of the cushions.

Brake systems which incorporate fixed calipers with opposed pistons use the above inboard cushion 12 design for each piston. This includes those pistons which apply an outboard brake pad.

Once the installation is complete, the cushions are ready to provide their benefits—there is no break-in period required. Every time the brakes are applied, the cushions instantly and automatically absorb any backward (lateral) movement of the brake pads, which is caused by high spots on the rotating rotor faces. Because of their unique characteristics of resilience, the cushions are able to absorb the lateral pad movement caused by rotor high spots, thereby practically eliminating the transfer of this motion to the caliper piston and caliper fingers. The result of this cushioning is that the brake pads are allowed to follow the irregularities (ride over the high spots) on the rotor friction faces during braking, which significantly reduces the severe frictional drag at rotor high spots. Reduced frictional drag means lower braking temperature, and lower braking temperature translates directly into increased braking efficiency and brake system longevity.

FIGS. 5,6, and 7—Additional Embodiments

The principle of the present invention (providing resilient cushioning for disc brake pads to accomplish the performance objectives described above) can be practiced using a variety of structures and/or materials. The important consideration concerning cushion manufacture is not so much what they are made of but whether they are capable of providing adequate and appropriate resilience for brake pads during braking. The preferred embodiment described above has been chosen because of performance, cost, and convenience considerations, but is not the only way to practice the invention.

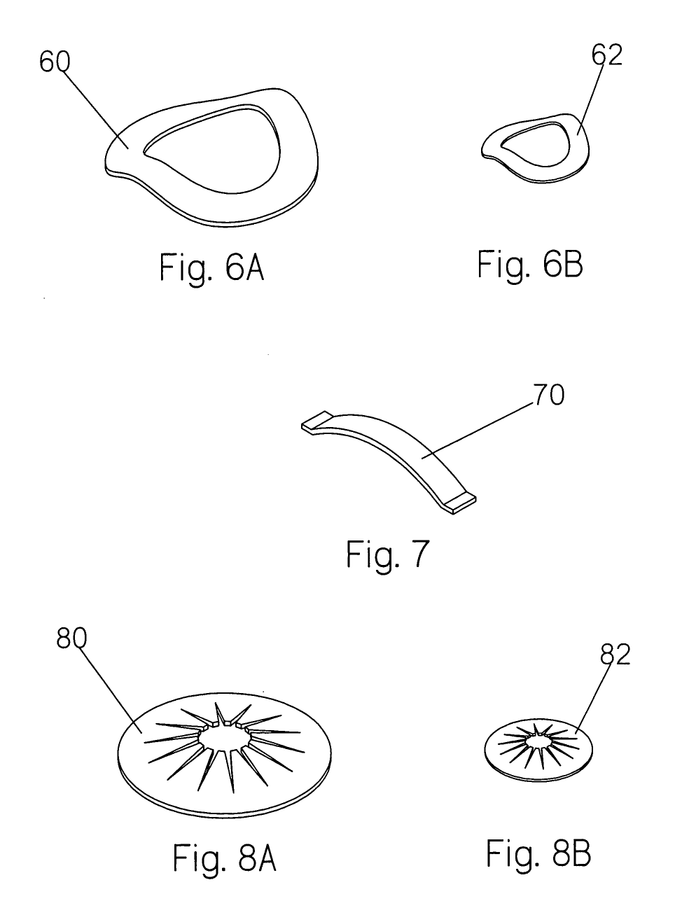

FIGS. 6A and 6B, for instance, show inboard wave spring cushion 60 and outboard wave spring cushion 62, respectively, which can be designed and calibrated to provide adequate and appropriate resilience during braking. The wave springs can be secured in place by a variety of conventional methods (not shown), including but not limited to spot welding, clips of various designs, rivets, screws, mating physical features, et cetera. The location of the wave springs in a typical disc brake system is essentially the same as the location of the preferred embodiment described above, and the operation during braking is identical to that of the preferred embodiment.

FIG. 7 shows a typical leaf spring 70 which can be designed, calibrated, and configured to provide adequate and appropriate resilience for inboard and outboard brake pads during braking. The leaf springs can be secured in place by a variety of conventional methods (not shown), similar to those listed for the wave springs described above. The location and operation of the leaf springs in a typical disc brake system is essentially the same as that of the preferred embodiment described above.

FIGS. 8A and 8B show inboard convex washer cushion 80 and outboard convex washer cushion 82, respectively, which can be designed and calibrated to provide adequate and appropriate resilience during braking. The convex washers can be secured in place by a variety of conventional methods (not shown), similar to those listed for the wave springs described above. The location and operation of the convex washers in a typical disc brake system is essentially the same as that of the preferred embodiment described above.

Advantages

The advantages provided by the brake pad cushions described above can be divided into three categories: Safety, Savings, and Other Advantages.

Safety Advantages

Shorter stopping distance is perhaps the most important safety-related improvement provided by the brake pad cushions. However, there are several other benefits derived from improved braking efficiency which are also critically important to driving safety. These additional safety benefits include:
(1) Shorter stopping time. More efficient deceleration means faster deceleration. The ability to stop in a shorter time helps to compensate for the slowed reaction times of elderly drivers, for poor visibility, and for surprises in traffic;
(2) Virtual elimination of brake “fade”. During heavy, frequent, or prolonged braking cycles, the coefficient of friction between pad and rotor surfaces is greatly diminished due to the excessive heat that is produced. The action of the brake pad cushions reduces the severe frictional drag at rotor high spots, keeping braking temperatures much lower and preventing (or at least delaying and lessening the degree of) brake fade;
(3) Reduction of lateral sway. During braking, the cushions provide for a smooth transfer of braking torque through the tires to the roadway, making for a much smoother stop, which significantly reduces lateral vehicle sway. This benefit is especially important for unevenly-loaded or high-bodied vehicles, as it helps to compensate for changes in center of gravity as vehicles are off-loaded, and for variations in tire pressures, etc. Smoother braking action also provides a noticeable improvement in steering control during hard braking, and remarkable braking stability when towing;
(4) Reduction of wheel lockup and skidding. The action of the cushions during braking reduces the severe frictional drag at rotor high spots, which in turn reduces the incidence of wheel lockup and skidding (on ABS-equipped vehicles, during “ABS-activated” stops, the cushions actually complement ABS action, making it smoother and providing a shorter stop); and
(5) Reduction in the number (and/or severity) of accidents. Brake performance is a critical factor in over 50% of accidents involving fatalities. The brake pad cushions of the present invention, because they provide both shorter and quicker stops, can be a significant factor in reducing not only fatalities, but also injuries and property damage.
   Saving Advantages

The action of the pad cushions during braking reduces the frictional drag at rotor high spots, which keeps friction interface temperatures much lower. Lower temperatures equal lower rates of wear for friction components (pads and rotors). As average braking temperatures increase, brake pad life expectancy correspondingly decreases. Reducing average braking temperatures from 800° F. to 400° F., for instance, more than doubles brake pad life expectancy. The reduction of braking temperatures which the present invention provides can generate substantial savings on brake pad replacement costs, as well as on replacement of other brake system components (rotors and calipers, most notably).

Another important effect of reducing the severe frictional drag at rotor high spots is the smoothing of the transfer of braking torque through the tires to the roadway. This effect lessens tire strain during braking, practically eliminating tire cupping and helping to reduce internal tire problems such as cord separation. Over the lifetime of any vehicle, the resulting savings from increased tire life can be quite significant.

Other Advantages

(1) The cushions are inexpensive for consumers;
(2) Cushion installation is very simple;
(3) The cushions do not require any “breaking-in”, and they never require any maintenance or adjustment;
(4) There is no re-engineering of the brake system involved in the installation of the cushions. No brake system components are altered or removed, and brake bias (front-to-rear balance) remains unchanged;
(5) The brake hydraulic system is not disturbed in any way during cushion installation, or by the action of the cushions during braking;
(6) The cushions are 100% compatible with any disc brake system and with any electronic ABS; and
(7) A set of disc brake pad cushions is a “fail-safe” device. Even if the cushions lost all resilience—or were removed entirely—the brake system would still operate as engineered from the factory.

### CONCLUSION, RAMIFICATIONS, AND SCOPE

Accordingly, the reader will see that the brake pad cushions of this invention are inexpensive, easy to install, and trouble-free during use. It is also evident that the cushions provide a profound benefit to personal safety (because of significant increases in braking efficiency) and remarkable savings (because of increased brake system longevity).

The description above contains many specificities, but these should not be construed as limits to the scope of the invention, but only as illustrations of some of the presently preferred embodiments. There are many “variations on the theme” which can accomplish the performance objectives described for this invention. For instance, elastomers other than rubber blends can be used, and any elastomeric cushion can be produced in a variety of shapes and sizes. Elastomeric cushions may also include a variety of surface protrusions, slits, or voids to compensate for shear forces (caused by worn brake pad abutments, for instance); shear forces may also be compensated by providing an anti-friction coating on one side of each cushion. Cushions may be caged or housed by stiffer materials to control “spread” of softer elastomers. Elastomeric cushions may also be impregnated with a variety of natural or synthetic materials (including but not limited to metallic springs or fiberglass fabric), to change or enhance physical properties or performance characteristics.

Metals or other materials can be used to make a variety of springs (including wave, leaf, or coil springs) which can satisfy the performance objectives set forth in this specification; any such spring may be combined with an elastomer or other material to change or enhance physical properties or performance characteristics.

Also, pneumatic or hydraulic dampers of various designs can be manufactured and secured in place between brake pads and their corresponding caliper members to provide adequate and appropriate resilience for brake pads during braking.

Clearly, the principle of this invention (to provide cushioning for brake pads which allows the pads to follow the irregularities (ride over the high spots) of their corresponding rotor faces during braking) can be practiced in a variety of ways. Accordingly, the scope of this invention should be determined not by the embodiments illustrated or described, but by the appended claims and their legal equivalents.

I claim:

1. Cushions for disc brake pads, comprising:
(a) resilient devices with predetermined characteristics of resilience, said resilient devices being capable of cushioning or absorbing any lateral movement of said disc brake pads during braking, said lateral movement of disc brake pads during braking being caused by irregularities or high spots on rotor friction faces, and
(b) means for securing said resilient devices in place between said disc brake pads and their corresponding caliper members,
whereby the frictional drag which occurs between said disc brake pads and said irregularities or high spots on rotor friction faces is substantially reduced, which results in significantly less brake-generated heat, increased braking efficiency, and increased brake system longevity.

2. The disc brake pad cushions of claim 1, wherein said resilient devices are made from an elastomer or an elastomeric compound.

3. The disc brake pad cushions of claim 2, wherein said resilient devices further include means for compensating for shear forces, said shear forces being caused by worn brake pad abutments, for instance.

4. The disc brake pad cushions of claim 1, wherein said resilient devices comprise wave springs.

5. The disc brake pad cushions of claim 1, wherein said resilient devices comprise leaf springs.

6. The disc brake pad cushions of claim 1, wherein said resilient devices comprise convex washers.

7. The disc brake pad cushions of claim 1, wherein said means for securing is selected from the group comprising adhesives, spot welds, clips of various designs, rivets, screws, mating physical features, et cetera.

8. The disc brake pad cushions of claim 7, wherein said means for securing is selected for use during brake pad or caliper manufacture, such that brake pads or caliper assemblies can be marketed with cushions either attached or included in brake pad or caliper packaging for attachment during brake pad or caliper installation.

9. In combination, a disc brake system having calipers for pressing disc brake pads against the friction faces of rotatable rotors, and means for allowing said disc brake pads to ride over the irregularities or high spots on said friction faces of rotatable rotors while under pressure during braking, said means for allowing having predetermined characteristics of resilience and being disposed between said disc brake pads and their corresponding caliper members, whereby the frictional drag which occurs between said disc brake pads and said irregularities or high spots on said friction faces of rotatable rotors is substantially reduced, which in turn reduces brake-generated heat and increases said disc brake system efficiency and longevity.

10. The combination of claim 9, wherein said means for allowing is made of an elastomer or an elastomeric compound.

11. The combination of claim 10, wherein said means for allowing further includes means for compensating shear forces.

12. The combination of claim 9, wherein said resilient means comprises wave springs.

13. The combination of claim 9, wherein said resilient means comprises leaf springs.

14. The combination of claim 9, wherein said resilient means comprises convex washers.

15. The combination of claim 9, wherein said resilient means is secured in place at the time of brake pad or caliper manufacture, or at the time of brake pad or caliper installation, or at any time during brake pad life, by using an appropriate fastening means selected from the group comprising adhesives, spot welds, clips of various designs, rivets, screws, mating physical features, et cetera.

16. A method for increasing the efficiency and longevity of disc brake systems, comprising:
(a) providing a disc brake system such as is commonly used on road vehicles,
(b) removing the disc brake pads from said disc brake system according to the manufacturer's instructions,
(c) cleaning the contact areas between said disc brake pads and their corresponding caliper members,
(d) providing resilient cushions with predetermined characteristics of resilience, such that said resilient cushions will absorb any lateral movement of said disc brake pads during braking, said lateral movement being caused by irregularities or high spots on the friction faces of rotating rotors,
(e) securing said resilient cushions in place between said disc brake pads and their corresponding caliper members by using an appropriate means selected from the group comprising adhesives, spot welds, clips of various designs, rivets, screws, mating physical features, et cetera, and
(f) reassembling said disc brake system according to the manufacturer's instructions.

17. The method of claim 16, wherein used disc brake pads are replaced by new disc brake pads.

18. The method of claim 16, wherein said resilient cushions are secured in place at the time of brake pad or caliper manufacture, or are included in brake pad or caliper packaging with appropriate means for securing, for use during said brake pad or caliper installation.
